(19) United States
(12) Patent Application Publication
(10) Pub. No.: US 2015/0330620 A1
(43) Pub. Date: Nov. 19, 2015

(54) LED LAMP ASSEMBLY

(71) Applicant: Tsung-Hsien Huang, I-Lan Hsien (TW)

(72) Inventor: Tsung-Hsien Huang, I-Lan Hsien (TW)

(21) Appl. No.: 14/809,277

(22) Filed: Jul. 26, 2015

Related U.S. Application Data
(63) Continuation-in-part of application No. 13/665,845, filed on Oct. 31, 2012, now Pat. No. 9,121,587.

(30) Foreign Application Priority Data
Jun. 13, 2012 (CN) 201210194026.5

(51) Int. Cl. F21V 29/77; F21V 3/00; F21V 17/16; F21K 99/00

(52) U.S. Cl. CPC F21V 29/773; F21K 9/1355; F21V 3/00; F21V 17/16; F21Y 2101/02

(57) ABSTRACT

An LED lamp assembly includes a heat-sink base having insertion notches equiangularly and radially located at a flat inner wall thereof, a plurality of radiation fins arranged in a radial array, each radiation fin having a plug portion disposed at a top side thereof and respectively inserted into one respective insertion notch of the heat-sink base and fixedly secured thereto using a stamping technique, a lampshade fastened to the radiation fins at the top side, an inner tube press-fitted into a center opening in the radiation fin set and affixed to the bottom side of the heat-sink base, and an insulative connector affixed to the bottom end of the inner tube.

### CROSS-REFERENCE TO RELATED APPLICATION

This application is a continuation-in-part of application Ser. No. 13/665,845 filed Oct. 31, 2012, which claims priority of China Patent Application No. 201210194026.5, filed on Jun. 13, 2012, the entirety of which is incorporated by reference herein.

### BACKGROUND OF THE INVENTION

(a) Field of the Invention The present invention relates to LED lamp technology and more particularly to a LED lamp assembly, which comprises a heat-sink base holding a series of LED devices, and a set of radiation fins arranged in a radial array.

(b) Description of the Prior Art

U.S. patent application Ser. No. 13/665,845 discloses LED lamp assembly consisting of a heat-sink base, a plurality of radiation fins, a lampshade and an insulative connector. According to this design, the insulative connector is a one-piece member configured according to a predetermined specification for a specific application. For connection to a different design of electrical receptacle, a different design of insulative connector should be made and provided for matching, increasing the cost.

### SUMMARY OF THE INVENTION

The present invention has been accomplished under the circumstances in view. It is the main object of the present invention to provide a LED lamp assembly, which is a continuation-in-part of patent application Ser. No. 13/665,845 and, which has a simple structure that can easily be assembled using a stamping technique.

To achieve this and other objects of the present invention, a LED lamp assembly comprises a radiation fin set defining a top open side, a heat-sink base mounted in the top open side of the radiation fin set to hold light-emitting diode means, an inner tube mounted in the radiation fin set, an insulative connector fastened to the inner tube at a bottom side, and a lampshade fastened to the radiation fin set over the top open side. The radiation fin set comprises a plurality of radiation fins arranged in a radial array and a center opening surrounded by the radiation fins. Each radiation fin comprises a plug portion disposed at a top side thereof. The heat-sink base is a flat metal block member comprising opposing flat outer wall and flat inner wall, a plurality of insertion notches equiangularly and radially located at the flat inner wall, and a plurality of mounting holes cut through the inner wall and the outer wall at selected locations. The inner tube is a hollow tubular member press-fitted into the center opening in the radiation fin set, comprising a plurality of mating connection holes equiangularly spaced around an inner perimeter thereof and respectively fastened to respective top ends of the respective mounting holes of the heat-sink base with respective fastening members. The insulative connector is hollow shell, comprising a thread-connection base made in the form of a lamp base with a metal ring contact extending around the periphery thereof and a metal center contact located at the center of a bottom end thereof and insulated from the metal ring contact, an expanded rim extending around an outer perimeter of a top end thereof, and a plurality of mounting holes equiangularly located at the expanded rim and respectively fastened to respective bottom ends of the respective mating connection holes of the inner tube with respective fastening members. After insertion of the plug portions of the radiation fins into the respective insertion notches of the heat-sink base, the insertion notches are deformed using a stamping technique, causing the plug portions of the radiation fins and the insertion notches of the heat-sink base to be fixedly fastened together.

### BRIEF DESCRIPTION OF THE DRAWINGS

FIG. 1 is an elevational view of a LED lamp assembly in accordance with the present invention.

FIG. 2 is an exploded view of the LED lamp assembly in accordance with the present invention.

FIG. 3 is an exploded view of a part of the present invention, illustrating the mounting arrangement between the radiation fin and the heat-sink base.

FIG. 4 is an exploded view of a part of the present invention, illustrating the mounting arrangement between the inner tube and the insulative connector.

FIG. 5 is a sectional side view of the LED lamp assembly in accordance with the present invention.

FIG. 6 is a schematic drawing illustrating the plug portions of the radiation fins inserted into the respective insertion notches of the heat-sink base before stamping.

FIG. 7 corresponds to FIG. 6, illustrating respective stamping punches moved toward the plug portions of the respective radiation fins.

FIG. 8 corresponds to FIG. 7, illustrating the stamping punches stamped against the plug portions of the respective radiation fins.

FIG. 9 corresponds to FIG. 8, illustrating the stamping punches moved away from plug portions of the respective radiation fins after stamping.

FIG. 10 is a perspective view in an enlarged scale of one radiation fin of the LED lamp assembly in accordance with the present invention.

### DETAILED DESCRIPTION OF THE PREFERRED EMBODIMENTS

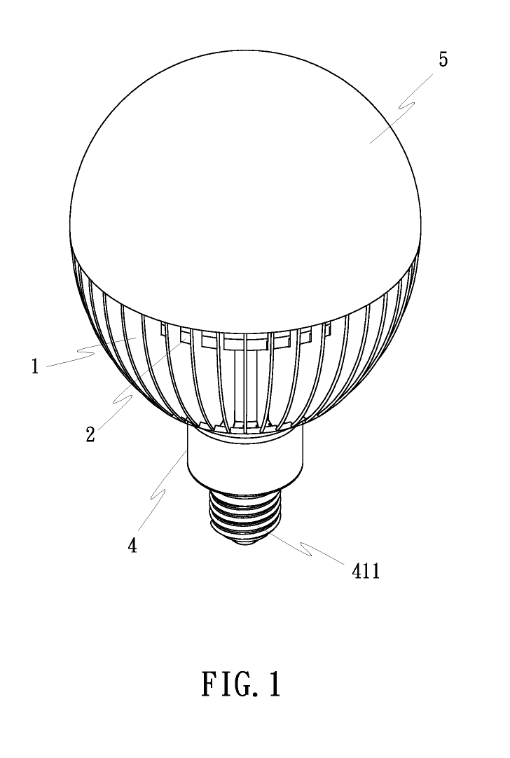

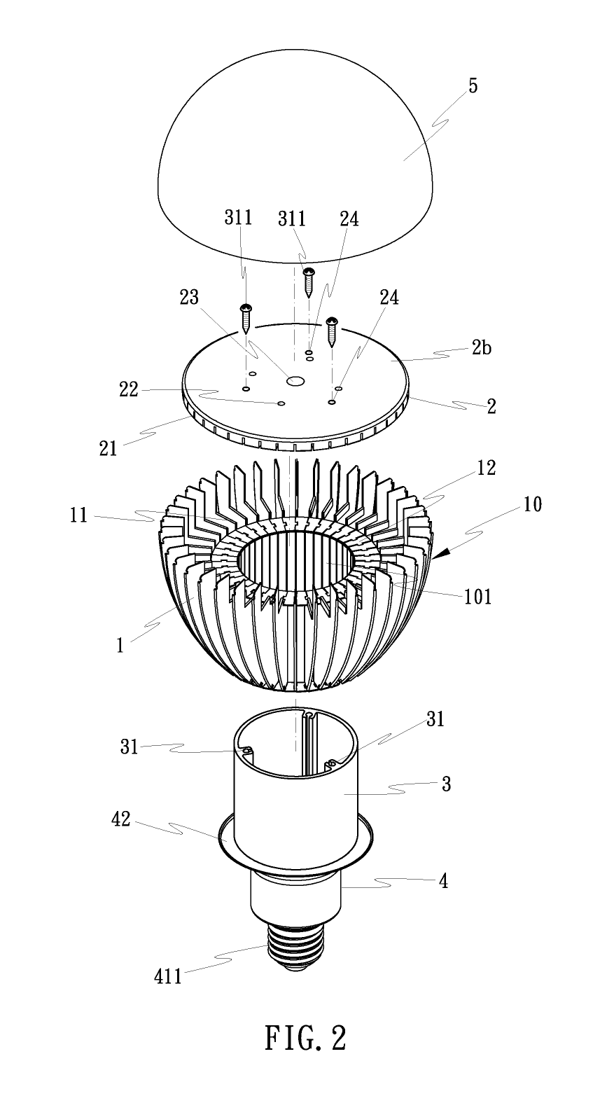

Referring to FIGS. 1 and 2, a LED lamp assembly in accordance with a first embodiment of the present invention is shown. The LED lamp assembly comprises a radiation fin set 10, a heat-sink base 2, an inner tube 3, an insulative connector 4, and a lampshade 5 fastened to a top open side of the radiation fin set 10.

The radiation fin set 10 comprises a plurality of radiation fins 1, a center opening 101 surrounded by the radiation fins 1. Each radiation fin 1 comprises a plug portion 11 vertically disposed at a top side thereof, and a bearing portion 12 horizontally inwardly extended from a bottom side of the plug portion 11. The plug portion 11 and the bearing portion 12 constitute a stepped structure. Further, the bearing portions 12 of the radiation fins 1 create an annular plane (see FIG. 2) for supporting the heat-sink base 2 in a direct contact manner so that heat energy absorbed by the heat-sink base 2 can be directly transferred to the radiation fins 1 for quick dissipation.

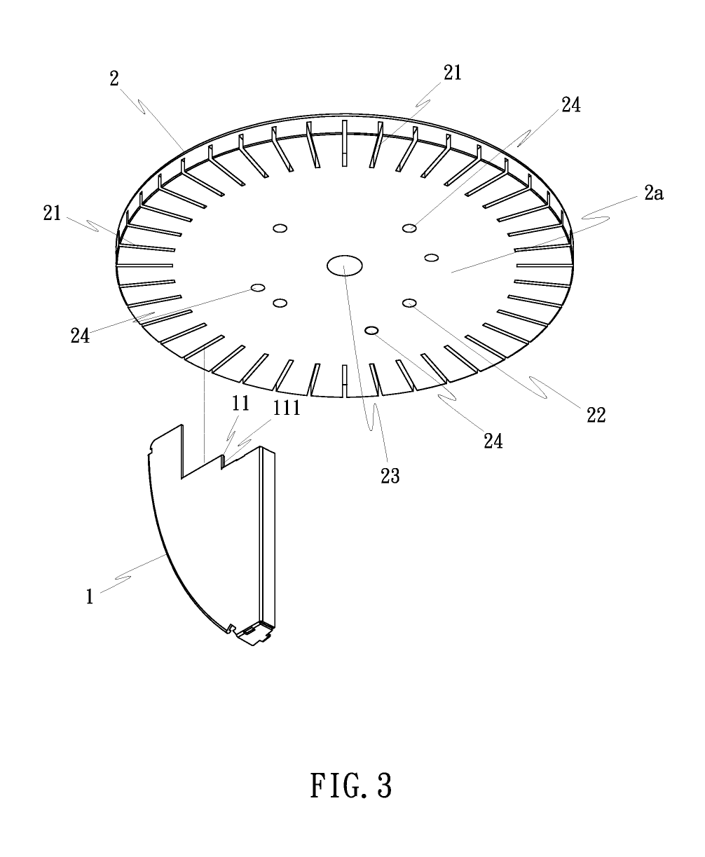

The heat-sink base 2, as shown FIG. 3, is a flat metal block member, comprising opposite flat inner wall 2a and outer wall 2b, a plurality of insertion notches 21 equiangularly and radially located at the flat inner wall 2a, a light-emitting unit formed of a series of LED devices (not shown) and mounted at the flat outer wall 2b, a plurality of through holes 22;23 cut through the opposing inner wall 2a and outer wall 2b for the passing of electrical wires (not shown) of the LED devices, and a plurality of mounting holes 24 cut through the opposing inner wall 2a and outer wall 2b at selected locations.

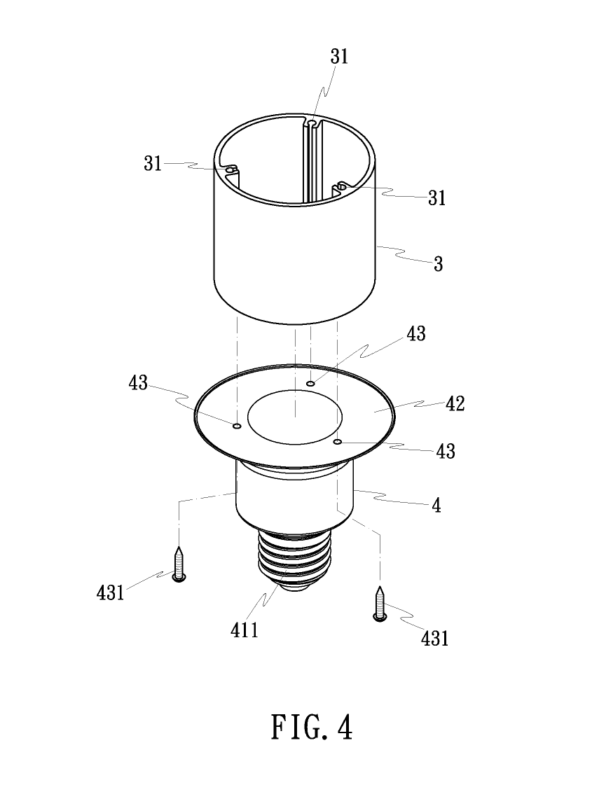

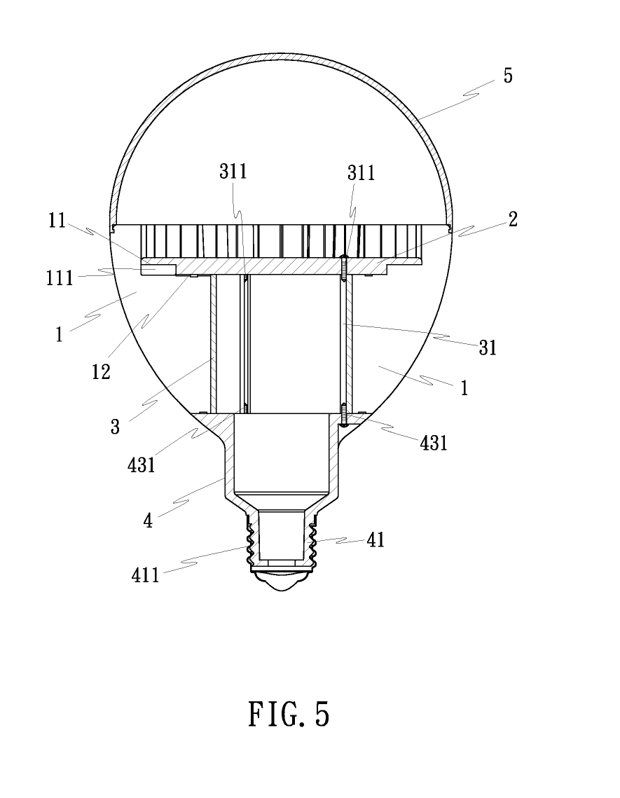

The inner tube 3, as shown in FIG. 4, is a hollow tubular member press-fitted into the center opening 101 in the radiation fin set 10, comprising a plurality of mating connection hole 31 equiangularly spaced around an inner perimeter thereof and respectively fastened to respective top ends of the respective mounting holes 24 of the heat-sink base 2 with respective fastening members, for example, mounting screws 311 (see FIG. 5). Thus, the inner tube 3 has the front end thereof fixedly connected to the inner wall 2a of the heat-sink base 2. Further, the opposing rear end of the inner tube 3 is connected to the insulative connector 4.

The insulative connector 4 can be configured subject to any of a variety of configurations. In this embodiment, the insulative connector 4 is hollow shell, comprising a thread-connection base 41 made in the form of a lamp base with a metal ring contact 411 extending around the periphery thereof and a metal center contact (not shown) located at the center of the bottom end thereof and insulated from the metal ring contact 411, an expanded rim 42 extending around an outer perimeter of a top end thereof, a plurality of mounting holes 43 equiangularly located at the expanded rim 42 and respectively fastened to respective bottom ends of the respective mating connection holes 31 of the inner tube 3 with respective fastening members, for example, mounting screws 431.

When assembling the LED lamp assembly, insert the plug portions 11 of the radiation fins 1 into the respective insertion notches 21 of the heat-sink base 2, and then employ a stamping technique to deform the insertion notches 21, causing the plug portions 11 of the radiation fins 1 and the insertion notches 21 of the heat-sink base 2 to be fixedly fastened together. Thereafter, fasten the opposing front and rear ends of the inner tube 3 to the heat-sink base 2 and the insulative connector 4, and then fasten the lampshade 5 to the top side of the radiation fin set 10.

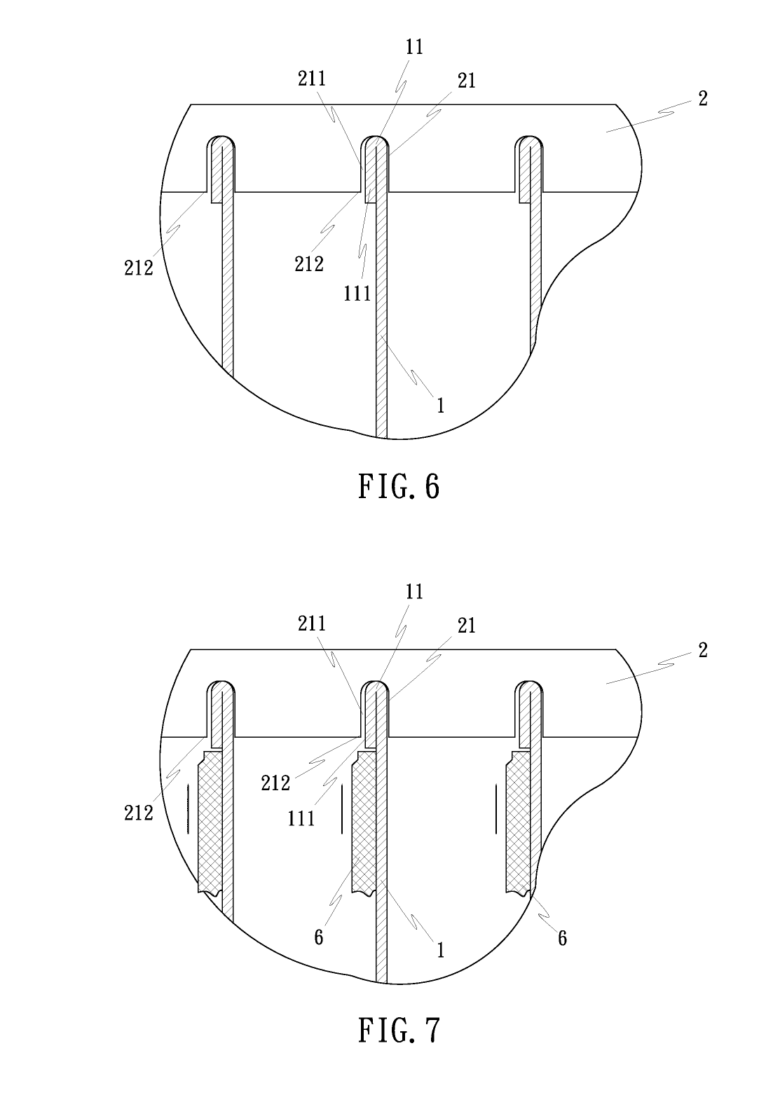

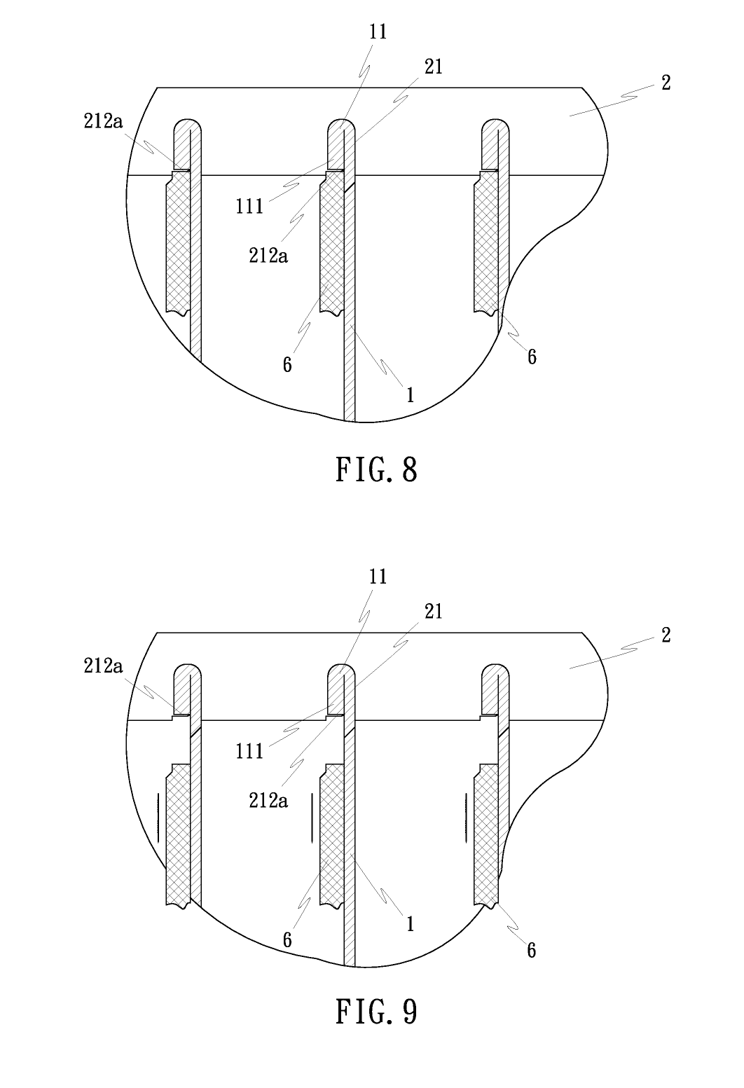

The plug portion 11 of each radiation fin 1 is a double-layer (or multi-layer) folded plug portion having a folded part 111 (see FIG. 6). The thickness of the double-layer (or multi-layer) folded plug portion 11 is slightly smaller than the width of each insertion notch 21 of the heat-sink base 2. After insertion of the plug portion 1 of each radiation fin 1 into one respective insertion notch 21 of the heat-sink base 2, a clearance 211 is left in the insertion notch 21 between the heat-sink base 2 and the plug portion 1 of the radiation fin 1. After insertion of the plug portions 11 of the radiation fins 1 into the respective insertion notches 21 of the heat-sink base 2 in a stamping press, as shown in FIGS. 7-9 (the stamping press is not shown), the stamping press is operated to stamp respective stamping punches 6 against the folded part 111 of the double-layer (or multi-layer) folded plug portion 11 of each respective radiation fin 1 and the heat-sink base 2, embedding the folded part 111 wholly in the respective insertion notch 21 to fill up the clearance 211, and deforming one lateral sidewall 212 of each insertion notch 21 to create a protrusion 212a that stops the folded part 111 of the double-layer (or multi-layer) folded plug portion 11 of the respective radiation fin 1 in the respective insertion notch 21. Thus, the radiation fins 1 are fixedly secured to the respective insertion notches 21 of the heat-sink base 2, and will not fall off or become loose.

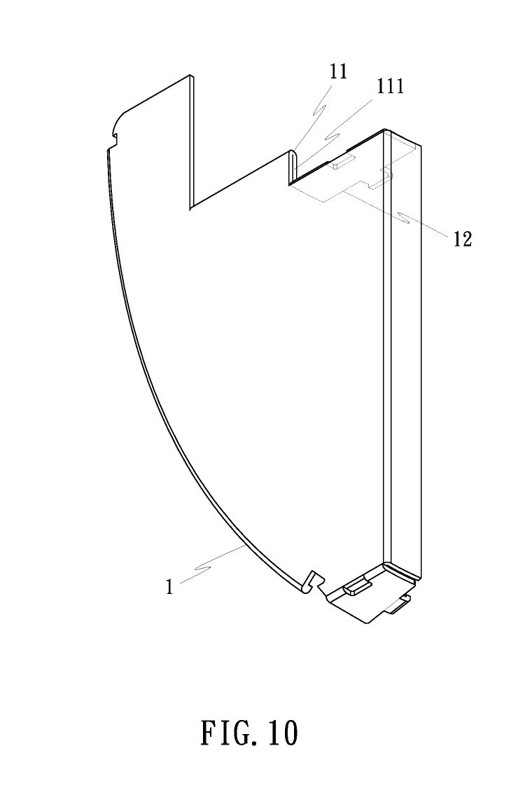

Referring to FIG. 10, each radiation fin 1 has a stepped structure at the top side thereof. The folded plug portion 11 of each radiation fin 1 is located at a middle part of the stepped structure. Each radiation fin 1 further comprises a horizontal protruding portion 12 located at the stepped structure thereof and abutted against an inner side of the folded plug portion 11 at a relatively lower elevation. After the plug portions 11 of the radiation fins 1 are respectively affixed to the respective insertion notches 21 of the heat-sink base 2, the horizontal protruding portions 12 of the radiation fins 1 are respectively horizontally abutted against one another, forming an annular plane (see FIG. 2) that is closely attached to the flat inner wall 2a of the heat-sink base 2 for quick transfer of waste heat from the heat-sink base 2 for quick dissipation into the outside open air.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A LED lamp assembly, comprising a radiation fin set defining a top open side, a heat-sink base mounted in said top open side of said radiation fin set to hold light-emitting diode means, an inner tube mounted in said radiation fin set, and an insulative connector fastened to said inner tube at a bottom side, wherein:
said radiation fin set comprises a plurality of radiation fins arranged in a radial array and a center opening surrounded by said radiation fins, each said radiation fin comprising a plug portion disposed at a top side thereof;
said heat-sink base is a flat metal block member comprising opposing flat outer wall and flat inner wall, a plurality of insertion notches equiangularly and radially located at said flat inner wall, and a plurality of mounting holes cut through said inner wall and said outer wall at selected locations;
said inner tube is a hollow tubular member press-fitted into said center opening in said radiation fin set, comprising a plurality of mating connection holes equiangularly spaced around an inner perimeter thereof and respectively fastened to respective top ends of the respective mounting holes of said heat-sink base with respective fastening members;
said insulative connector is hollow shell, comprising a thread-connection base made in the form of a lamp base with a metal ring contact extending around the periphery thereof and a metal center contact located at the center of a bottom end thereof and insulated from said metal ring contact, an expanded rim extending around an outer perimeter of a top end thereof, a plurality of mounting holes equiangularly located at said expanded rim and respectively fastened to respective bottom ends of the respective mating connection holes of said inner tube with respective fastening members;
wherein after insertion of said plug portions of said radiation fins into the respective said insertion notches of said heat-sink base, said insertion notches are deformed using a stamping technique, causing said plug portions of said radiation fins and said insertion notches of said heat-sink base to be fixedly fastened together.

2. The LED lamp assembly as claimed in claim 1, further comprising a lampshade fastened to said radiation fin set over said top open side.

3. The LED lamp assembly as claimed in claim 1, wherein said heat-sink base comprises a plurality of through holes extending through said flat inner wall and said flat outer wall.

4. The LED lamp assembly as claimed in claim 1, wherein the plug portion of each said radiation fin is a folded plug portion having a folded part, the thickness of the folded plug portion of each said radiation fin being smaller than the width of each said insertion notch of said heat-sink base before insertion, the folded plug portions of said radiation fins being embedded in the respective said insertion notches of said heat-sink base after application of said stamping technique.

5. The LED lamp assembly as claimed in claim 1, wherein each said radiation fin of said radiation fin set has a stepped structure at the top side thereof; the plug portion of each said radiation fin is located at a middle part of the stepped structure of the respective said radiation fin.

6. The LED lamp assembly as claimed in claim 5, wherein each said radiation fin further comprises a bearing portion horizontally inwardly extended from a bottom side of the plug portion thereof, the bearing portions of said radiation fins creating an annular plane for supporting said heat-sink base in a direct contact manner.
